(19) United States
(12) Patent Application Publication
(10) Pub. No.: US 2025/0141560 A1
(43) Pub. Date: May 1, 2025

(54) PHOTOCURRENT SENSING FOR FEEDBACK CONTROL

(71) Applicant: MaxLinear, Inc., Carlsbad, CA (US)

(72) Inventors: Abdelkrim El Amili, San Diego, CA (US); Mario Milicevic, Irvine, CA (US); Curtis Ling, Carlsbad, CA (US)

(73) Assignee: MaxLinear, Inc., Carlsbad, CA (US)

(21) Appl. No.: 18/929,528

(22) Filed: Oct. 28, 2024

Related U.S. Application Data
(60) Provisional application No. 63/593,704, filed on Oct. 27, 2023.
(60) Provisional application No. 63/556,396, filed on Feb. 21, 2024.

(51) Int. Cl. H04B 10/50; G02B 6/40; H04B 10/071; H04B 10/40

(52) U.S. Cl. CPC H04B 10/5057; G02B 6/40; H04B 10/071; H04B 10/40; H04B 10/504

(57) ABSTRACT

An electro-absorption modulated laser may include a first diode and a second diode. The first diode may be operable to receive a first voltage and generate a first output. The second diode may be coupled to the first diode and may be operable to receive a second voltage. The second diode may generate a photocurrent using the first output and the second voltage.

### CROSS REFERENCE TO RELATED APPLICATIONS

This U.S. Patent application claims priority to U.S. Provisional Patent Application No. 63/593,704, titled “PHOTOCURRENT SENSING FOR FEEDBACK CONTROL,” and filed on Oct. 27, 2023, and to U.S. Provisional Patent Application No. 63/556,396, titled “PHOTOCURRENT SENSING FOR FEEDBACK CONTROL,” and filed on Feb. 21, 2024, the disclosure of which are hereby incorporated by reference in their entirety.

### TECHNICAL FIELD

This disclosure relates to optical data transmission, and more specifically, to the use of photocurrent sensing to optimize the performance of optical data transmission.

### BACKGROUND

Unless otherwise indicated herein, the materials described herein are not prior art to the claims in the present application and are not admitted to be prior art by inclusion in this section.

State-of-the-art optical transceivers for datacenter applications may operate at symbol rates beyond 56 gigabits per second. One way to transmit optical signals at these speeds may include using high-speed electronic circuits to drive the modulator terminal of a high-speed electro-optical device called an electro-absorption modulated laser (EML), thereby converting an electrical signal to one carried by laser light. The EML may include a distributed-feedback laser which may feed an electro-absorption (EA) modulator. The EA modulator may take the form of a PIN diode whose absorptive properties may be dependent on the voltage applied to terminals of the EA modulator. In some instances, output of the EML may suffer from degradation in certain environments. Degradations can cause the generated optical signal to have increased amounts of noise that can in some instances result in loss of data. For example, existing systems may rely on lookup tables to adjust operation of the EML to accommodate operating temperature variations. While these types of methods may be beneficial in certain use cases, such methods may be unable to account for some issues, such as faulty factory calibration or system/component degradation over time. Furthermore, use of lookup tables may require an extra calibration step to be performed when connecting a fiber optic cable to an optical receiver of an optical transceiver.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

In an example embodiment, an electro-absorption modulated laser (EML) may include a first diode and a second diode. The first diode may be operable to receive a first voltage and generate a first output. The second diode may be coupled to the first diode and may be operable to receive a second voltage. The second diode may generate a photocurrent using the first output and the second voltage.

In another embodiment, a device may include an EML and sensing circuitry. The EML may include a first diode and a second diode. The first diode may be operable to receive a first voltage and generate a first output. The second diode may be coupled to the first diode and may be operable to receive a second voltage. The second diode may generate a photocurrent using the first output and the second voltage. In response to the sensing circuitry determining the photocurrent exceeds a threshold, the sensing circuitry may cause an adjustment to the second voltage such that an output from the EML may be adjusted.

In another embodiment, a method may include obtaining a first voltage at a first diode. The method may also include generating a first output by the first diode, which may be in response to the first voltage. The method may further include obtaining a second voltage at a second diode. The method may also include generating a photocurrent by the second diode. The photocurrent may be generated by the second diode in response to the first output and the second voltage.

The objects and advantages of the embodiments will be realized and achieved at least by the elements, features, and combinations particularly pointed out in the claims. Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIGS. 1A and 1B illustrate an example electro-absorption modulated laser device and an example implementation of the electro-absorption modulated laser device;

FIG. 2 illustrates an example system including the electro-absorption modulated laser device of FIG. 1A;

FIGS. 3A and 3B illustrate graphs of example responses of an electro-absorption modulated laser device to various input voltages;

FIG. 4A illustrates an example configuration of an optical transceiver including sensing circuitry illustrated in FIG. 2;

FIG. 4B illustrates another example configuration of an optical transceiver including sensing circuitry illustrated in FIG. 2;

FIG. 5 illustrates an example configuration of a distributed amplifier system;

FIG. 6 illustrates a flowchart of an example method of photocurrent sensing for feedback control; and

FIG. 7 illustrates equations described in the present disclosure.

### DETAILED DESCRIPTION

An electro-absorption modulated laser (EML) naturally produces a photoelectric current during operation, and correspondingly, a nonlinear transfer function associated with the modulation voltage applied. In many present systems and devices, the photocurrent is ignored. Further, many present systems and device utilize a monitor photodiode to sense distributed feedback (DFB) laser power

Aspects of the present disclosure address these and other limitations by monitoring the photocurrent generated in a transceiver by a modulator in an EML and/or utilizing the photocurrent as feedback in the transceiver. The photocurrent may be used at least to monitor the DFB laser power in the transceiver, improve the quality of optical signal output from the transceiver, adjust the modulator in the EML to improve the modulation amplitude and/or the extinction ratio, and/or for alignment purposes of the optical components in the transceiver.

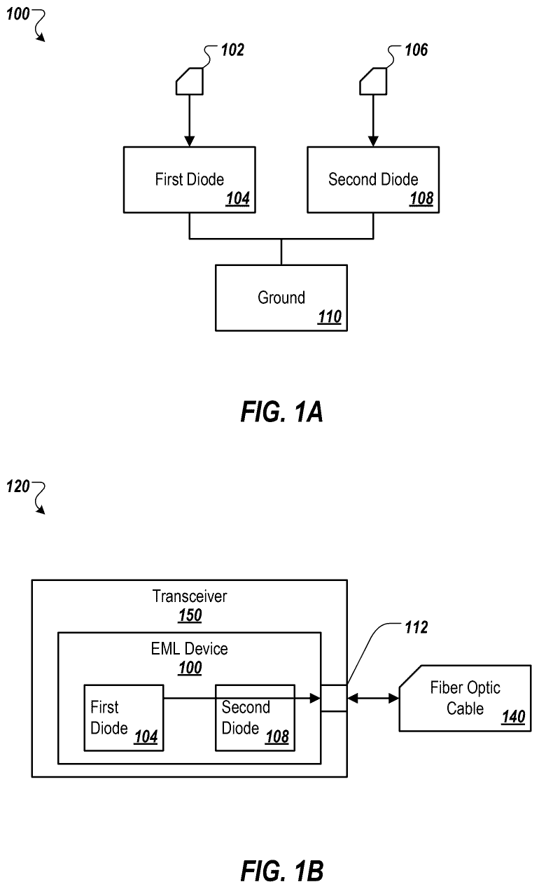

FIG. 1A illustrates an example electro-absorption modulated laser (EML) device 100, in accordance with at least one embodiment of the present disclosure. The EML device 100 may include a first diode 104, a second diode 108, and a ground 110. FIG. 1B illustrates the EML device 100 implemented in an example system 120. The system 120 may include a transceiver 150, the EML device 100 (e.g., the same or similar to the EML device 100 of FIG. 1A), and a housing 112.

The operation of the EML device 100 may be based on a first voltage 102 driving the first diode 104 and a second voltage 106 being applied to the second diode 108. In some instances, the first voltage 102 may be a laser bias voltage and the second voltage 106 may be a modulation voltage. In some instances, changes in the second voltage 106 may vary the strength of an electric field generated within the second diode 108. In response to the variation to the electric field in the second diode 108, the absorption coefficient of the second diode 108 may change, which may vary the amount of laser energy passing through the second diode 108 and out of the EML device 100.

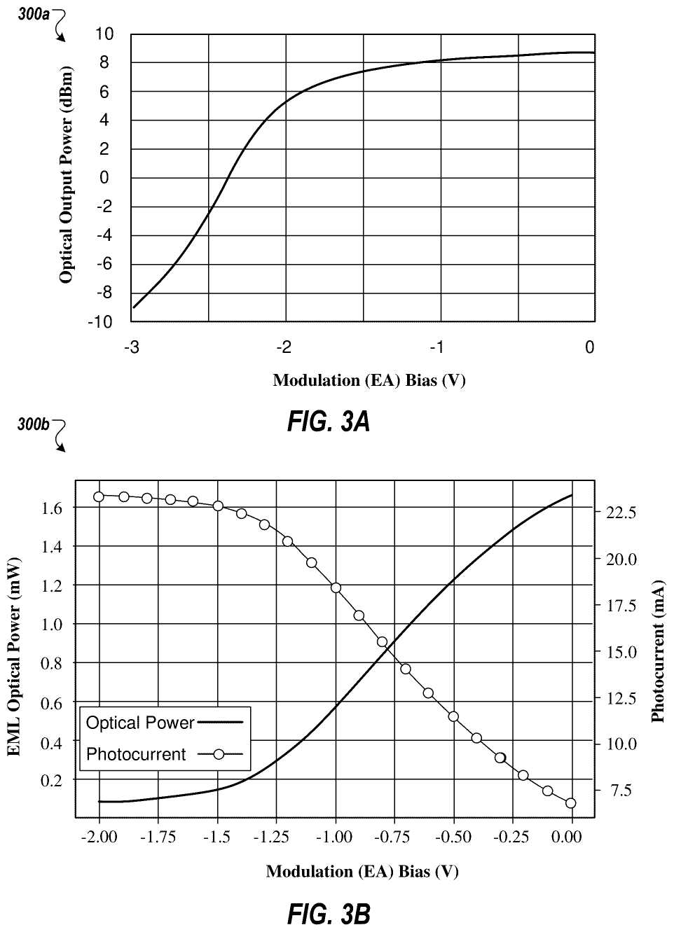

In some instances, the second diode 108 may be a photodiode or a PIN type photodiode. In some instances, changes to the absorption coefficient of the second diode may be accomplished when the second voltage 106 is negative and then applied to the second diode 108. In some embodiments, some results of an application of the second voltage 106 to the second diode 108 may be illustrated in FIGS. 3A and 3B.

During operation, the first voltage 102 may be held at a substantially constant value while the second voltage 106 may be varied. The variations in the second voltage 106 may result in encoded data transmissions in the output of the EML device 100. As illustrated in FIG. 1B, the output of the EML device 100 may be received by a fiber optic cable 140. It should be noted that the first diode 104 and the second diode 108 are shown sharing the ground 112 as such configuration may represent the EML device 100 designed such that the first diode 104 and the second diode 108 are integrated into a single chip. Other configurations are also contemplated (e.g., where the first diode 104 and the second diode 108 are on separate chips) where a first ground may be associated with the first diode 104 and a second ground may be associated with the second diode 108.

In some instances, the first diode 104 may be a laser diode and the second diode 108 may be an electro-absorption (EA) modulator. The first diode 104 may be a distributed feedback (DFB) laser, other various laser diodes (e.g., an EA modulator with an external laser, a distributed Bragg reflector (DBR) laser, etc.). Alternatively, or additionally, the second diode 108 may be a PIN diode.

As illustrated in FIG. 1B, the system 120 may be the transceiver 150 that may include the EML device 100. In some instances, the transceiver 150 may include the housing 112 that may include one or more ports configured to couple the fiber optic cable 140 to the transceiver 150. In some instances, the transceiver 150 may be an optical transceiver and/or the housing may include multiple ports such that multiple fiber optic cables may be coupled to the transceiver 150. The fiber optic cable 140 may include a ferrule disposed at the end thereof, which may be used to couple to the housing 112 of the transceiver 150. Other methods of coupling the fiber optic cable 140 to the transceiver 150 may be utilized. In some instances, the transceiver 150 may include circuitry configured to send to and/or receive data from the second diode 108 from a server or other computing device that may be used to drive changes the second voltage 106.

In some instances, the output from the EML device 100 and/or the transceiver 150 may be an optical signal and the optical signal may include an optical waveform. In some instances, the photocurrent associated with the EML device 100 may be proportional to the optical waveform from the EML device 100. In such instances, the photocurrent may be used to provide feedback for adjusting the optical waveform, such that the quality of the optical waveform may be improved relative to not making adjustments based on the photocurrent. In these and other embodiments, a temperature look-up table may be used to determine a temperature and associated variation to the curves (e.g., the curves illustrated in FIGS. 3A and 3B herein) associated with the EML device 100 to improve the optical waveform.

Modifications, additions, or omissions may be made to the EML device 100 without departing from the scope of the present disclosure. For example, the designations of different elements in the manner described is meant to help explain concepts described herein and is not limiting. Further, the EML device 100 may include any number of other elements or may be implemented within other systems or contexts than those described. For example, any of the components of FIG. 1 may be divided into additional or combined into fewer components.

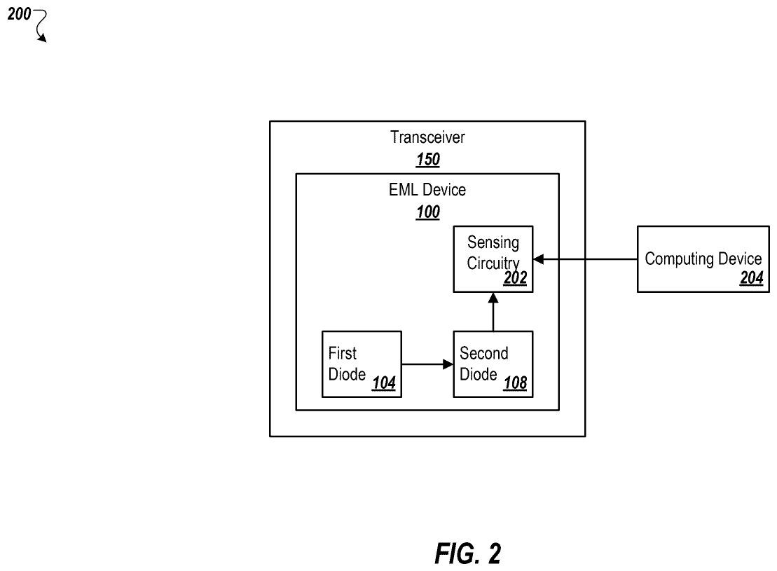

FIG. 2 illustrates an example system 200 including the EML device 100 of FIG. 1A, in accordance with at least one embodiment of the present disclosure. The system 200 may include the transceiver 150 as described relative to FIG. 1B, and a computing device 204. Alternatively, or additionally, the transceiver 150 may include the EML device 100, which may be similar to the EML device 100 of FIGS. 1A and 1B. As illustrated in FIG. 2, the EML device 100 may include sensing circuitry 202.

In some instances, the sensing circuitry 202 may be configured to monitor an output generated by the second diode 108, which output may be associated with performance of the EML device 100. In some instances, the output of the second diode 108 may be a photocurrent, as described herein. As illustrated in FIG. 2, the transceiver 150 may be electrically coupled to the computing device 204, which may be external to the transceiver 150. In some instances, the computing device 204 may be responsible for generating or at least contributing to the generation of the second voltage 106. In some instances, the computing device 204 may be a datacenter server and/or other computing device that may be wired in to a high speed data network.

In some instances, the sensing circuitry 202 may include one or more processors that may be configured to monitor variation in the photocurrent. Variations in the photocurrent from the second diode 108 as detected by the sensing circuitry 202 may be used to adjust operation of the EML device 100. For example, the sensing circuitry 202 may be configured to adjust output from the EML device 100 when readings detected by the sensing circuitry 202 indicate the EML device 100 is operating outside of a predetermined range. Alternatively, or additionally, the sensing circuitry 202 may be configured to delay any adjustments to the output of the EML device 100 to confirm any variation to the output may not be transient in nature. Alternatively, or additionally, in some instances, the output from the EML device 100 may be fed into a closed loop feedback control scheme. In some instances, the sensing circuitry 202 may be on a die separate from the EML device 100. Alternatively, or additionally, the sensing circuitry 202 may be implemented on the same die as the EML device 100.

Modifications, additions, or omissions may be made to the EML device 100 without departing from the scope of the present disclosure. For example, the designations of different elements in the manner described is meant to help explain concepts described herein and is not limiting. Further, the EML device 100 may include any number of other elements or may be implemented within other systems or contexts than those described. For example, any of the components of FIG. 1 may be divided into additional or combined into fewer components.

FIGS. 3A and 3B illustrate graphs 300a and 300b of example responses of an EML device to various input voltages, in accordance with at least one embodiment of the present disclosure. The graphs 300a and 300b may represent performance of an EML device that may include components such as a DFB laser and a PIN diode. While EML devices can take many forms, as described herein, the graphs 300a and 300b may be associated with a particular implementation. It should be appreciated that the particular implementation should not be construed as limiting the scope of other devices described herein.

The graph 300a of FIG. 3A illustrates how application of a negative voltage at an electro-absorptive (EA) modulator (e.g., the second diode 108 of FIG. 1A) of an EML device may reduce an output power of the EML device. The curve depicted in the graph 300a may be defined by the output power of the laser diode and characteristics of the EA modulator. The voltage applied to the laser diode may define the magnitude of raw output of the EML device with no voltage applied to the EA modulator. This raw output may define an extinction ratio associated with the EML device, which may include a ratio of the maximum optical power to the minimum optical power of the EML device. High extinction ratios may be of value in instances in which an EML device may be used for high-speed optical communication systems as the high extinction ratio may increase the amount of variation possible in the laser output as a function of variations in the modulation bias. However, power output of the laser diode may be limited to a point where a desired extinction ratio may be reached in order to avoid unneeded expenditures of power and/or buildup of heat within an associated optical transceiver (which may include an EML device).

A modulation bias voltage may be selected such that the EML device may operate in a portion of the curve where variations in the modulation voltage may cause relatively larger variations in the output of the EML device. In such a configuration, signal modulations may be distinguished from one another, and/or the likelihood of signal corruption may be reduced. For an EML device having an output response as illustrated in FIG. 3A, a value in the range of approximately-2.5V to 2.25V may facilitate modulations in the modulation bias to be maximized as this portion of the curve may have the steepest slope.

In some instances, an algorithm may be used to adjust the modulation bias voltage in order to be used to track the performance of the slope associated with the photocurrent (e.g., the slope of the curve in FIG. 3A). For example, the modulation bias voltage may be changed by an amount (dV) and the corresponding change in current may be detected (dI). Subsequently, a ratio of the change in current relative to the change in voltage (e.g., dI/dV) may be calculated. The results of the ratio may be used to determine at least one additional change to the modulation bias voltage. For example, in instances in which the ratio is positive, no change may be performed to the modulation bias voltage. In instances in which the ratio is negative, the sign (e.g., positive or negative) of the modulation bias voltage may be reversed. In these and other embodiments, the algorithm may be executed at a slower rate relative to the symbol rate in the transmitted data, and/or the algorithm may be executed at a faster rate than the rate the temperature in the system may drift.

The graph 300b of FIG. 3B illustrates another EML device in which less negative voltage may be used to establish operation of the EML device in a region of the curve in which changes in output power may be maximized. As illustrated in the graph 300b, a reverse voltage of between −1.0V and −0.5V may be used to operate in a state where minor changes in modulation bias voltage may result in discernable changes in optical output power of the EML device. Alternatively, or additionally, the graph 300b may illustrate how the EML device may generate a photocurrent that may be proportional to the strength of the laser. A determination of an approximate optical power output may be made by monitoring the photocurrent generated by the EA modulator. By monitoring the photocurrent, adjustments may be made to the operation of the EML device to keep the EML device operating within a desired operating window. For example, in instances in which a manufacturer wants the EML device to have a consistent output power of approximately 0.9 mW, a controller can be used to adjust the modulation bias voltage until a photocurrent of about 14 mA may be detected. In some instances, a modulation bias voltage of −0.75V may achieve a photocurrent of approximately 14 mA under normal operating conditions, but variations in temperature and/or degradation to the EML device (e.g., due to aging of the components of the EML device) may result in a need to adjust the modulation bias of the EML device to achieve a desired operating state (e.g., approximately 14 mA in the example). In some instances, the use of photocurrent-based feedback control may reduce and/or removes the need for time-consuming calibration to be performed on each optical transceiver prior to sale or installation.

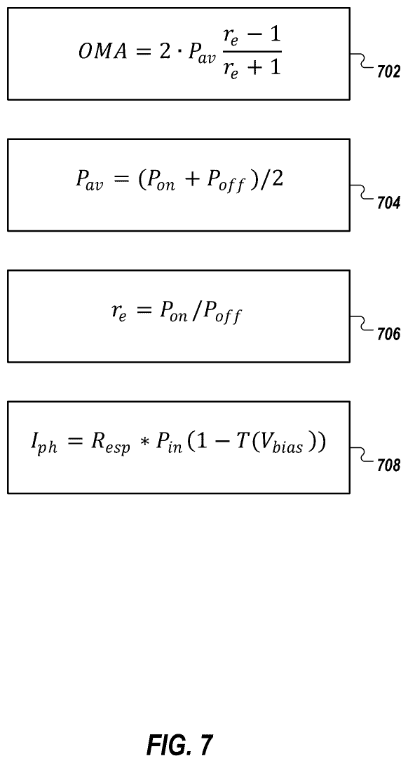

In some instances, the EA modulator may have a modulation transfer function, which may be a nonlinear function of the modulation voltage associated with the EA modulator (also referred to as the EA voltage). As described, when a varying signal is applied to the EA modulator, variations to the absorption of the EA modulator may cause a modulation to the optical power output of the EML device, as shown in the graphs 300a and 300b of FIGS. 3A and 3B, respectively. The mean value of the signal applied to the EA modulator terminal may be set to optimize the optical modulation amplitude (OMA) by referencing measured photocurrent values from the EA modulator. The OMA may be computed mathematically by equations 702, 704, and 706 in FIG. 7.

Equation 704 may define Pₐᵥ from equation 702 as an average of the laser power output with the EA modulator fully engaged (Pₒₙ) and the EA modulator unpowered (P_{off}). Equation 706 may define re from equation 702 as a ratio of Pₒₙ and P_{off}. The photocurrent output illustrated in the graph 300b of FIG. 3B may be governed by equation 708 in FIG. 7.

In equation 708, Rₑₛₚ may represent the responsivity of the EA modulator, Pin may be the optical power at the input of the EA modulator, and T (V_{bias}) may represent the nonlinear transmission of the EA modulator.

In these and other embodiments, variations in the curves illustrated in FIGS. 3A and 3B may be used to perform predictive maintenance in a system in which the EML device is included. For example, as the curves change (which may be due to thermal drift and/or aging electronics), the response of the corresponding EML device may also change. Based on the changes to the EML device (e.g., from monitoring the variations in the curves), alternate routing in the system may be utilized to avoid the degrading/degraded EML device and the EML device may be replaced. In some instances, the degraded EML device may be replaced prior to failure, which may improve performance in a system that includes multiple EML devices as workload may be adjusted from the degraded EML device to non-degraded EML devices and the degraded EML device may be replaced.

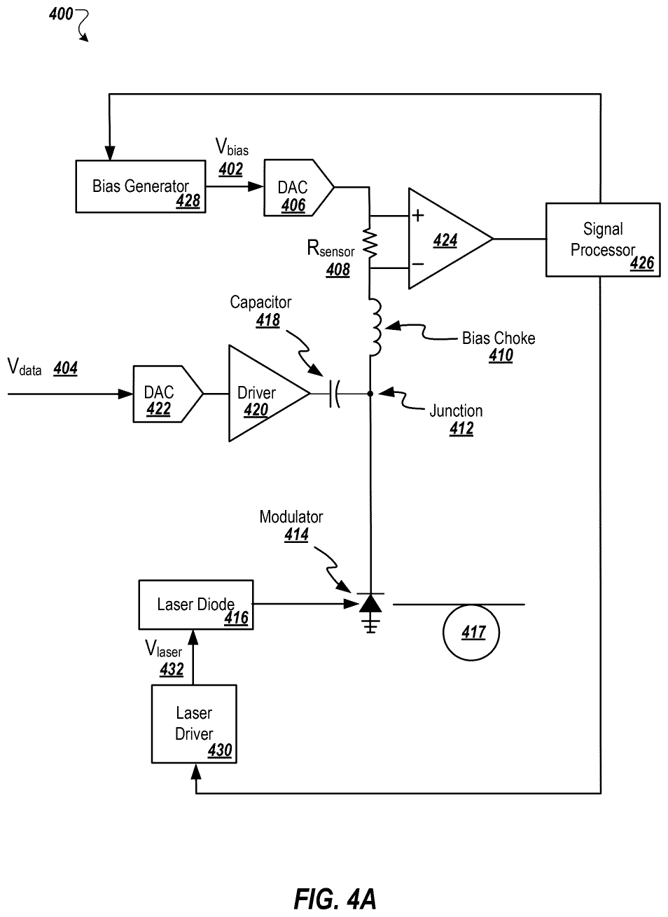

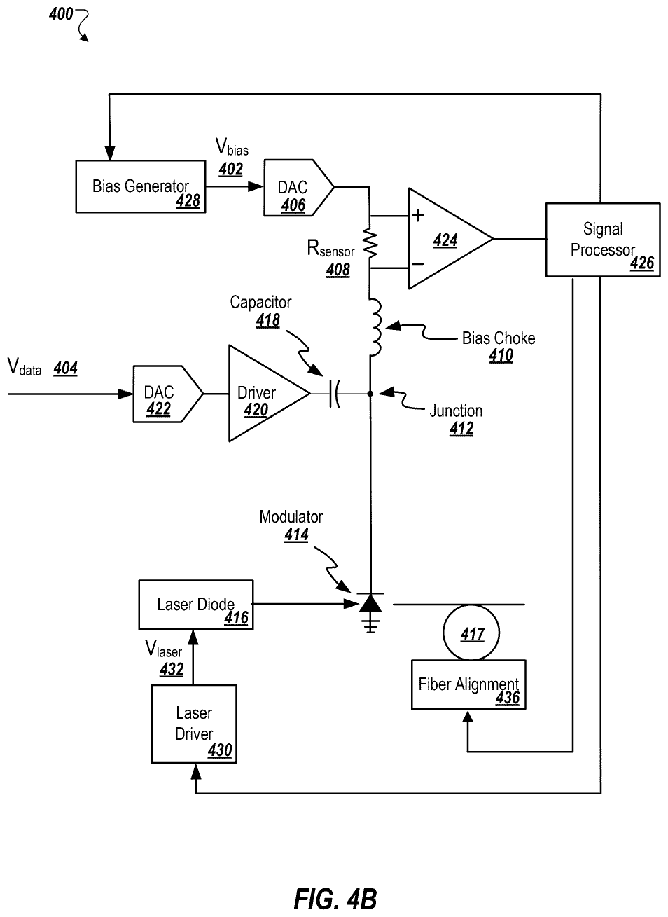

FIG. 4A illustrates an example configuration of an optical transceiver 400 including sensing circuitry illustrated in FIG. 2, in accordance with at least one embodiment of the present disclosure. In particular, a modulation voltage (e.g., the second voltage 106 in FIG. 1A) may be represented by bias voltage 402 and data voltage 404. The bias voltage 402 may be set to a value that may cause the EA modulator to be in a range of operation that may be suited to provide a strong response to modulation in the data voltage 404 (e.g., as described relative to FIGS. 3A and 3B). Considerations for setting the bias voltage 402 are discussed in greater detail in the text accompanying FIGS. 3A and 3B. The data voltage 404 may be encoded to include digital data communications received from a computing device or a server utilizing the optical transceiver 400.

The optical transceiver 400 illustrates how the bias voltage 402 may be converted from a digital to analog signal by a DAC 406. The bias voltage 402 may be a negative voltage that may be routed through a sensor resistor 408 and/or a bias choke 410 before combining with the data voltage 404 at junction 412. The combination of the bias voltage 402 and the data voltage 404 may be received at a modulator 414, which may generate an electric field within the modulator 414 that modulates the output of light generated by laser diode 416 and may be subsequently received at fiber 417.

Application of the bias voltage 402 and/or the data voltage 404 to the modulator 414 increases the absorption of photons passing through the modulator 414. Absorption of the photons by the modulator 414 causes the modulator 414 to generate a photocurrent that flows back through the junction 412, the bias choke 410 and/or the sensor resistor 408. In some embodiments, the photocurrent may be prevented from flowing back toward the input line for the data voltage 404 by a polarized capacitor 418 that may be positioned in front of a driver 420 and/or a DAC 422, both of which may be responsible for processing the data voltage 404. The bias choke 410 may take the form of an inductor that may be configured to filter out high frequency modulations resulting from the encoded data introduced by modulations in the data voltage 404. In such arrangement, the photocurrent arriving and going across sensor resistor 408 may be a stable current representative of the average photonic absorption occurring at the modulator 414. A current sensor 424 may be operable to measure the photocurrent flowing across the sensor resistor 408. In some instances, current measurements may be received at a signal processor 426, where the signal processor 426 may be responsible for monitoring the photocurrent and/or making changes to the operation of a bias generator 428 and/or the driver 420. As the signal processor 426 may be responsible for making adjustments based on a steady state operation of the optical transceiver 400, photocurrent measurements at the current sensor 424 may be limited to a preconfigured rate, such as between 100 and 1000 kHz.

In some instances, the signal processor 426 may be configured to adjust the output of the bias generator 428 when the measured photocurrent indicates the optical power output is outside of a desired operating range. The signal processor 426 may be configured to make the optical power output determination by referencing a look up table containing output power data, modulation bias data, and/or photocurrent data (e.g., similar to data illustrated in FIGS. 3A and/or 3B). For example, using an optical transceiver that may be similar to the one modeled in FIG. 3B and that may be configured to output a bias voltage of −0.75 V, a photocurrent of approximately 15 mA may be observed with a corresponding optical power output of about 0.9 mW. In another example, in instances in which the photocurrent measured by the current sensor 424 is showing 13 mA, the signal processor 426 may determine that the actual optical power output is higher than desired at about 1.1 mW. In such instances, the signal processor 426 may be configured to adjust (e.g., increase) the bias voltage until the current sensor 424 measures a photocurrent of about 15 mA. The signal processor 426 may implement such changes by transmitting one or more control commands to the bias generator 428.

Such adjustments may be utilized to correct issues that may be caused by transient issues in the optical transceiver 400, such as buildup of heat in the optical transceiver 400. In some instances, the signal processor 426 may be operable to make other changes to the operation of the optical transceiver 400. For example, in instances in which detected changes in the photocurrent are consistent with operations being affected by an increase in heat buildup within the optical transceiver 400, the signal processor 426 may direct operation of a cooling component within the optical transceiver 400 or a heat dissipation device external to the optical transceiver 400 to attempt to dissipate heat from optical transceiver 400.

In some instances, the signal processor 426 may be operable to adjust a laser voltage 432 of the laser driver 430. Changes to the laser driver 430 may be implemented when performance of the optical transceiver 400 may be degraded (e.g., degradation of the laser diode 416 due to aging or damage caused by mechanical stress and/or electrostatic shock). The signal processor 426 may be configured to make adjustments to the laser voltage 432 and/or laser current inputs to compensate for degradation of the laser diode 416. The signal processor 426 may make such changes to the laser diode inputs in situations where photocurrent measurements may be observed to be consistently lower over time, which may indicate a degradation in the laser voltage 432. The signal processor 426 may also be operable to provide a warning to a user (e.g., an administrator of a datacenter) when degradation of the laser diode 416 may be determined to have exceeded a predetermined threshold, where a replacement of the laser diode 416 and/or the optical transceiver 400 may be recommended.

In some instances, the signal processor 426 may be operable to implement closed loop feedback control of the optical transceiver 400 based on the detected photocurrent. The signal processor 426, the bias generator 428, and/or the laser driver 430 may include a controller such as a proportional integral derivative (PID) controller, a linear-quadratic regulator (LQR) controller, and/or other controllers which may be operable to implement changes to the bias voltage 402 or the laser voltage 432 in a manner that may facilitate a controlled transition in steady state operations of the optical transceiver 400.

FIG. 4B illustrates an example configuration of an optical transceiver 400 including sensing circuitry illustrated in FIG. 2, in accordance with at least one embodiment of the present disclosure. The optical transceiver 400 may be similar to the optical transceiver 400 of FIG. 4A, and may further include a fiber alignment module 436. The configuration of optical transceiver 400 illustrated in FIG. 2B may be used to align of the fiber 417 with the optical transceiver 400.

In some instances, the signal processor 426 may be placed in communication with the fiber alignment module 436 that may be operable to align the fiber 417 with laser energy exiting the modulator 414. While the fiber alignment module 436 is illustrated within the optical transceiver 400, it should be appreciated that the fiber alignment module 436 may be disposed outside the optical transceiver 400 as the fiber alignment module 436 may be a diagnostic tool that may not be present during operation of the optical transceiver 400. In some instances, the optical transceiver 400 may include a service port (not illustrated) that may facilitate an attachment of a cable between the optical transceiver 400 and the fiber alignment module 436, where the cable and/or the service port may enable communication between the signal processor 426 and the fiber alignment module 436.

The fiber alignment module 436 may be configured to shift the position and/or the orientation of the end of the fiber 417 based on photocurrent measurements and/or analysis provided by the signal processor 426. In some instances, a distal end of the fiber 417 may include a reflective end, such that laser energy received by the fiber 417 may be reflected back into the modulator 414. The optical transceiver 400 of FIG. 4B is described in terms of the use of a reflective fiber termination, however, it should be appreciated that other reflective devices or components can be used to calibrate the proper position of the fiber 417 relative to the optical transceiver 400.

As described, the modulator 414 may be configured to generate a photocurrent regardless of the direction photons are transmitted through the modulator 414. Consequently, light reflected back into the modulator 414 may affect the photocurrent sensed by the current sensor 424 and the reflected light may be used to provide the fiber alignment module 436 with feedback on the preciseness of the alignment of the fiber 417 with the laser energy exiting the modulator 414. The fiber alignment module 436 may vary the position of the fiber 417 relative to the modulator 414 and by referencing the changes in the measured photocurrent, the fiber alignment module 436 may identify a location for the fiber 417 relative to the modulator 414. The method described herein may be used to help confirm and/or position the location of optical ports on the optical transceiver 400. For example, using the photocurrent generated by the modulator 414 for feedback in the alignment process may eliminate the need for the fiber alignment module 436 to have a dedicated sensor to monitor the energy output through modulator 414.

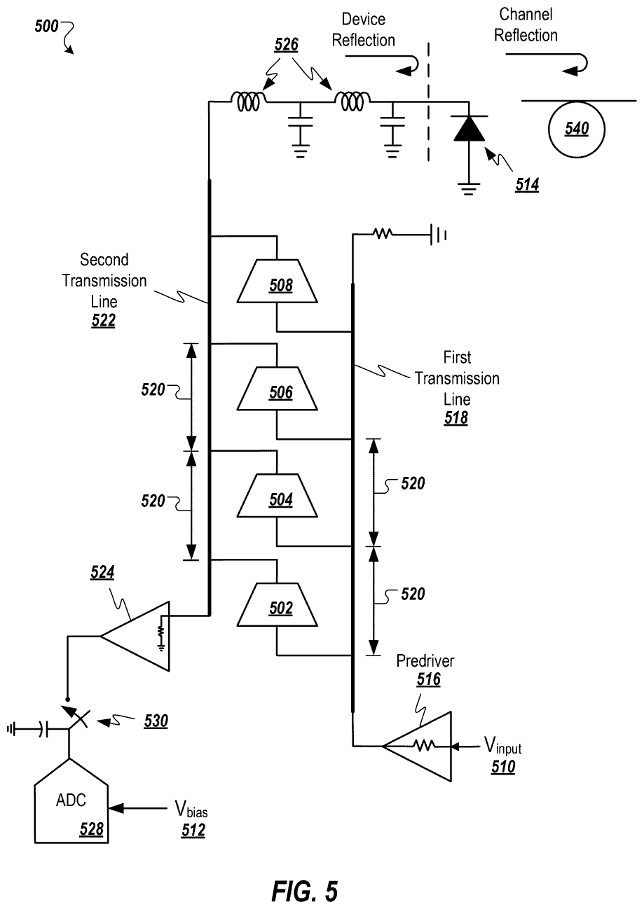

FIG. 5 illustrates an example configuration of a distributed amplifier system 500 (or system 500), in accordance with at least one embodiment of the present disclosure. The system 500 may include amplifiers 502, 504, 506, and 508, a modulator 514, a predriver 516, a first transmission line 518, a second transmission line 522, a measurement device 524, inductors 526, an analog to digital converter 528, a switching element 530, and a fiber optic cable 540. In some instances, the system 500 may be operable to improve the performance of a modulator (as described herein, such as the second diode 108) associated with a high speed communication system. The amplifiers 502, 504, 506, and 508 used in the system 500 may be transistors, but may also take the form of diodes and/or travelling-wave amplifiers. The system 500 illustrated in FIG. 5 includes a four amplifier configuration, however it should be appreciated that many other configurations of amplifiers may be implemented, such as two or as many as ten or twenty amplifiers may be incorporated into an example system similar to the system 500. Some examples of transistor type amplifiers include heterojunction bipolar transistors (HBTs), high-electron-mobility transistors (HEMTs), indium gallium phosphide (InGaP) HBTs, and/or silicon-germanium (SiGe) HBTs. Use of the system 500 for communications may provide a wider bandwidth, lower gain ripple, higher power handling capacity, improved linearity, and/or enhanced efficiency relative to communication systems not including the distributed amplifiers as described.

The system 500 may include two inputs: an input signal voltage 510 and a bias voltage 512. The input signal voltage 510 may be modulated to encode data and the bias voltage 512 may be set at a level designed to allow the combined signal to drive operation of the modulator 514. In some instances, the input signal voltage 510 may be input first into the predriver 516 prior to entering the first transmission line 518. The predriver 516 may have a resistance, such as about 40 ohms as an example. The first transmission line 518 may be a waveguide or a coaxial cable. A length of the first transmission line 518 may be set to minimize the occurrence of signal reflection by setting the length of the first transmission line 518 as a multiple of a wavelength associated with the input signal voltage 510 exiting the predriver 516. In some instances, a distance 520 between each branch off of the first transmission line 518 leading to a respective one of the amplifiers 502, 504, 506, and/or 508 may correspond to the wavelength associated with the input signal voltage 510. The distance 520 between the branches leading from the amplifiers 502, 504, 506, and 508 and intersecting with the second transmission line 522 may be approximately the same length and/or may correspond to the wavelength associated with the input signal voltage 510.

The distributed amplifiers in the system 500 may facilitate improved signal linearity compared with a traditional amplifier configuration, such as similar to the driver 420 in FIG. 4A. The distributed amplifiers in the system 500 may achieve improved linearity as the gain stages may be distributed along the first transmission line 518. As such, any non-linearities caused by an individual amplifier may be averaged out. The averaging of the amplifiers may contribute to determining the output of the modulator using the photocurrent measurements made at the measurement device 524, where the measurement device 524 may be configured to measure the photocurrent generated by the modulator 514. While not depicted in the system 500 illustrated in FIG. 5, for an EML setup, this configuration may further include a laser diode configured to output a laser that travels through the modulator 514 and the fiber optic cable 540 and/or may also include a signal processor for adjusting performance of the modulator 514 based on measurements made by the measurement device 524, as previously described herein.

In some instances, the measurement device 524 may be configured to measure device reflections and/or channel reflections moving upstream from the modulator 514 through the second transmission line 522 to measure and/or optimize performance of the modulator 514. In some instances, a photocurrent and/or reflections measured at the measurement device 524 may be used together to further improve performance of the modulator 514. In some instances, the inductors 526 may be operable to further reduce signal reflections and/or perform frequency filtering.

Alternatively, or additionally, the system 500 may be operable to remove or substantially remove reflections that may occur from the system 500, such that detected reflections may be representative of reflections that may occur in the channel, such as in the fiber optic cable 540. Using the channel reflections, an improved understanding of the channel may be developed, which may include whether there is alignment within the channel. As such, no receiver device (e.g., that may be remote from the system 500) may be needed to determine alignment of the optical components, as the channel reflections may be used to determine the alignment. Alternatively, or additionally, a remote laser may be directed to the system 500 via the fiber optic cable 540 and the system 500 may operate as a photodiode, and using the properties of the system 500 described herein, an alignment of the optical components may be determined by maximizing the power from the remote laser to align the fiber optic cable 540.

FIG. 5 also illustrates how the bias voltage 512 is shown passing through the analog to digital converter 528 and through the switching element 530. In some instances, the switching element 530 may be a high speed switching element. The analog to digital converter 528 and the switching element 530 may contribute to matching and/or synchronizing the bias voltage 512 and the input signal voltage 510, such as when the bias voltage 512 and the input signal voltage 510 are combined at the second transmission line 522.

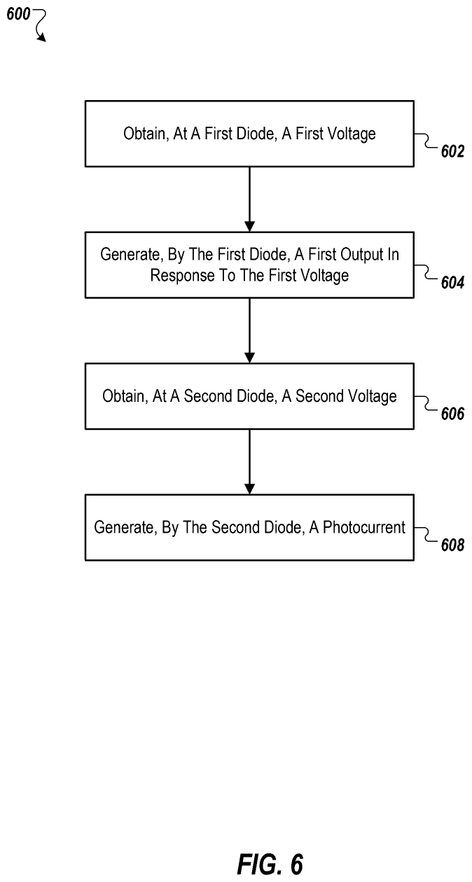

FIG. 6 illustrates a flowchart of an example method 600 of photocurrent sensing for feedback control, in accordance with at least one embodiment of the present disclosure. The method 600 may be performed by processing logic that may include hardware (circuitry, dedicated logic, etc.), software (such as is run on a general purpose computer system or a dedicated machine), or a combination of both, and where the processing logic may be included in any computer system or device.

For simplicity of explanation, the method 600 described herein is depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At block 602, a first voltage may be obtained at a first diode. In some instances, the first voltage may be a laser bias voltage.

At block 604, a first output may be generated in response to the first voltage. The first output may be generated by the first diode.

At block 606, a second voltage may be obtained at a second diode. In some instances, the second voltage may be a modulation voltage.

At block 608, a photocurrent may be generated by the second diode. The photocurrent may be generated in response to the first output and the second voltage. In some instances, the laser bias voltage may be held constant and the modulation voltage may be varied such that the photocurrent may include an encoded data transmission. Alternatively, or additionally, the photocurrent may be used to adjust a bias point associated with the second voltage to improve an optical modulation amplitude and/or an extinction ratio.

Modifications, additions, or omissions may be made to the method 600 without departing from the scope of the present disclosure. For example, in some instances, an optical signal may be output from an electro-absorption modulated laser that may be associated with the first diode and the second diode. The optical signal may be based at least on the photocurrent. In another example, a reflection of the optical signal may be obtained and an optical alignment of the electro-absorption modulated laser may be performed using the optical signal and/or the reflected optical signal.

In another example, the designations of different elements in the manner described is meant to help explain concepts described herein and is not limiting. Further, the method 600 may include any number of other elements or may be implemented within other systems or contexts than those described.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although implementations of the present disclosure have been described in detail, various changes, substitutions, and alterations could be made hereto without departing from the spirit and scope of the present disclosure.

What is claimed is:

1. An electro-absorption modulated laser, comprising:
a first diode operable to receive a first voltage to generate a first output; and
a second diode coupled to the first diode and operable to receive a second voltage, wherein the second diode generates a photocurrent using the first output and the second voltage.

2. The electro-absorption modulated laser of claim 1, wherein the first voltage is a laser bias voltage and the second voltage is a modulation voltage.

3. The electro-absorption modulated laser of claim 2, wherein the laser bias voltage is held constant and the modulation voltage is varied such that the photocurrent comprises an encoded data transmission.

4. The electro-absorption modulated laser of claim 1, wherein the photocurrent is proportional to an optical waveform output from the electro-absorption modulated laser.

5. The electro-absorption modulated laser of claim 4, wherein the photocurrent provides feedback to the electro-absorption modulated laser and the feedback is used to improve the quality of an eye diagram associated with the optical waveform.

6. The electro-absorption modulated laser of claim 1, wherein the photocurrent is used to adjust a bias point associated with the second voltage to improve an optical modulation amplitude and an extinction ratio.

7. The electro-absorption modulated laser of claim 1, wherein the photocurrent is used to perform an optical alignment associated with the electro-absorption modulated laser.

8. A device, comprising:
an electro-absorption modulated laser, comprising:
a first diode operable to receive a first voltage to generate a first output; and
a second diode coupled to the first diode and operable to receive a second voltage, wherein the second diode generates a photocurrent using the first output and the second voltage; and
sensing circuitry,
wherein in response to the sensing circuitry determining the photocurrent exceeds a threshold, the sensing circuitry causes an adjustment to the second voltage such that an output from the electro-absorption modulated laser is adjusted.

9. The device of claim 8, wherein the first voltage is a laser bias voltage and the second voltage is a modulation voltage.

10. The device of claim 8, wherein the laser bias voltage is held constant and the modulation voltage is varied such that the photocurrent comprises an encoded data transmission.

11. The device of claim 8, wherein the photocurrent is proportional to an optical waveform output from the electro-absorption modulated laser.

12. The device of claim 11, wherein the photocurrent provides feedback to the electro-absorption modulated laser and the feedback is used to improve the quality of an eye diagram associated with the optical waveform.

13. The device of claim 8, wherein the photocurrent is used to adjust a bias point associated with the second voltage to improve an optical modulation amplitude and an extinction ratio.

14. The device of claim 8, wherein the photocurrent is used to perform an optical alignment associated with the electro-absorption modulated laser.

15. A method, comprising:
obtaining, at a first diode, a first voltage;
generating, by the first diode, a first output in response to the first voltage;
obtaining, at a second diode, a second voltage;
generating, by the second diode, a photocurrent, wherein the photocurrent is generated by the second diode in response to the first output and the second voltage.

16. The method of claim 15, further comprising outputting an optical signal from an electro-absorption modulated laser associated with the first diode and the second diode based at least on the photocurrent.

17. The method of claim 16, further comprising:
obtaining a reflection of the optical signal;
performing an optical alignment of the electro-absorption modulated laser using the optical signal and the reflected optical signal.

18. The method of claim 15, wherein the first voltage is a laser bias voltage and the second voltage is a modulation voltage.

19. The method of claim 18, wherein the laser bias voltage is held constant and the modulation voltage is varied such that the photocurrent comprises an encoded data transmission.

20. The method of claim 15, wherein the photocurrent is used to adjust a bias point associated with the second voltage to improve an optical modulation amplitude and an extinction ratio.
